(19) United States
(12) Patent Application Publication
(10) Pub. No.: US 2015/0379531 A1
(43) Pub. Date: Dec. 31, 2015

(54) SYSTEM AND METHOD FOR MANAGEMENT OF MOBILE BUSINESS PROFITABILITY

(71) Applicant: Go Daddy Operating Company, LLC, Scottsdale, AZ (US)

(72) Inventors: James Christian, Scottsdale, AZ (US); Rajinder Nijjer, Phoenix, AZ (US); Karen Trueblood Munoz, Scottsdale, AZ (US)

(21) Appl. No.: 14/316,651

(22) Filed: Jun. 26, 2014

(51) Int. Cl. G06Q 30/02

(52) U.S. Cl. CPC G06Q 30/0202; G06Q 50/12

(57) ABSTRACT

A system and method for identification of at least one profitable location for mobile business users are presented. The method includes receiving, by a profitability location engine communicatively coupled to a network, a request for a list of profitable locations for one or more mobile business users with a region. The profitability location engine receives business input data associated with a business of the mobile business user, and generates output prediction data. The output prediction data includes one or more profitable locations for the business. A report including the profitable locations is displayed to the mobile business users.

### BACKGROUND OF THE INVENTION

The present invention relates to systems and methods for management of mobile business profitability. More particularly, the invention relates to systems and methods for predicting profitable locations for mobile food trucks to conduct business.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between users. Hundreds of millions of people around the world have access to computers connected to the Internet via Internet Service Providers (ISPs). Content providers distribute content, such as multimedia information, including text, graphics, audio, video, animations, and other forms of data to consumers using the Internet. In addition, businesses utilize the Internet to facilitate business transactions and communicate between buyers and sellers, suppliers and customers, and many other entities.

The Internet has been elevated to an essential tool of commerce around the world and its prevalence in business continues to expand. The Internet continues to be increasingly valuable to individual users and businesses alike. Many people use the Internet for everyday tasks, from social networking, shopping, banking, and paying bills to consuming media and entertainment. Thus, the buying and selling of products or services over electronic systems such as the Internet, or eCommerce, continues to grow.

The mobile food industry is relatively new. Accordingly, there is little to no historical data on which to base management decisions and the industry is only beginning to explore how to utilize tools such as the Internet in delivering food more efficiently and effectively. In total, there are roughly 3 million food truck businesses in the U.S. with estimated revenues of 650 million dollars in 2013. Because location can be key to the success of a food truck, mobile food businesses can spend $360 to over $500 on gas each month driving from one location to another in an attempt to maximize profits.

Typically a mobile food business will park on a street or corner to conduct business. However, the operator of the mobile food business may not necessarily know if their daily location will be profitable or if they will lose money. Accordingly, location selection can be a key challenge for food truck operators. Furthermore, not only do mobile food businesses often deal with changing locations and a transient customer base, in many instances, the food truck's menu changes as well. Given that a food truck is mobile, vendors follow a unique set of challenges and must comply with regulations wherever they travel. As a result, mobile food businesses suffer many inefficiencies due to the constantly changing environment in which they operate.

Unlike a restaurant, which has a fixed location, mobile food businesses may change their location several times in a single day. In addition, mobile food businesses may have menus that change regularly since they may serve a different customer base in different locations. Also unlike a restaurant, mobile food businesses must comply with certain municipal regulations, such as no parking zones (which can, in some cases, be temporary restrictions) or school zones. As another example, some municipalities require mobile food businesses to obtain a parking permit from the municipality's transportation department for one or more spaces to ensure clear area in the front and rear of the truck. Other municipalities may restrict mobile food business from parking within a certain distance of restaurants, for example.

Thus, there is a need for a system and method that allows mobile food businesses to compile sales data, optimize menus for various locations, and determine locations that are most profitable. Collecting, organizing, and analyzing data generated in this manner may help mobile food businesses optimize routes, pricing, menus, and food quantity under various conditions while complying with municipal regulations.

### SUMMARY OF THE INVENTION

The present invention overcomes the aforementioned drawbacks by providing a system and method for tracking business input data related to mobile food businesses including, but not limited to, sales, orders, revenue, location, time of orders, weather conditions, and day of the week. A software application is provided that compiles the business data from one or more smart phones or devices of mobile food businesses using a profitability location engine. The profitability location engine may be configured to display output prediction data in the form of a report or map, for example, that indicates one or more locations as being profitable for the mobile food business. In addition, the report and/or map may indicate municipal regulations, such as no parking zones, for a particular location so the mobile food business can avoid fines and penalties from the municipality. The profitability location engine may further be configured to provide the mobile food business with a daily or weekly route, for example, to instruct the business owner where to go at a given time or day that will be most profitable. Lastly, the profitability location engine may be configured to compile a profitability map based on the locations of the mobile food business for the past week, month, year, and the like, and indicates an estimated profit at the various locations.

In accordance with one aspect of the invention, a method includes receiving, by a profitability location engine communicatively coupled to a network, a request for a list of profitable locations for at least one mobile business user within a region. The profitability location engine receives business input data associated with a business of the one or more one mobile business users and generates output prediction data. The output prediction data includes at least one profitable location for the one or more mobile business users. A report is displayed by the profitability location engine and includes the at least one profitable location for the one or more mobile business users.

In accordance with another aspect of the inventions, a method includes issuing a request, from a mobile business, for a list of profitable locations to a profitability location engine. Business input data associated with the mobile business is transmitted to the profitability location engine. Output prediction data is received from the profitability location engine. The output prediction data is based on the business input data and includes the list of profitable locations. The list of profitable locations is displayed as a report to the mobile business.

In accordance with another aspect of the invention, a system includes a profitability location engine communicatively coupled to a network. The profitability location engine is configured to receive a request for a list of profitable locations for one or more business users within a region. The profitability location engine receives business input data associated with a business of the one or more mobile business users. Output prediction data is generated and includes at least one profitable location for the mobile business users. A report including the one or more profitable locations is displayed to the mobile business user.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a schematic view of an environment in which an embodiment of the present disclosure may operate.

FIG. 2 is a flow chart setting forth the steps of processes for generating one or more profitable locations for a mobile business user.

FIG. 3 shows an example screen shot of an example user interface including a route suggestion and schedule for the mobile business user.

FIG. 4 shows an example screen shot of an example user interface including a map displaying one or more profitable locations.

FIG. 5 shows an example screen shot of an example user interface by which the mobile business user can adjust one or more settings.

FIG. 6 shows an example screen shot of an example user interface including a performance chart displaying profitability of previously visited locations of the mobile business user.

### DETAILED DESCRIPTION OF THE INVENTION

This description primarily discusses illustrative embodiments as being implemented in conjunction with mobile food businesses. It should be noted, however, that discussion of mobile food businesses is simply one example of many different types of mobile businesses that apply to illustrative embodiments. For example, various embodiments may apply to mobile businesses such as farmers markets, pet grooming, ATMs, florists, and the like. Accordingly, discussion of mobile food businesses is not intended to limit various embodiments of the invention.

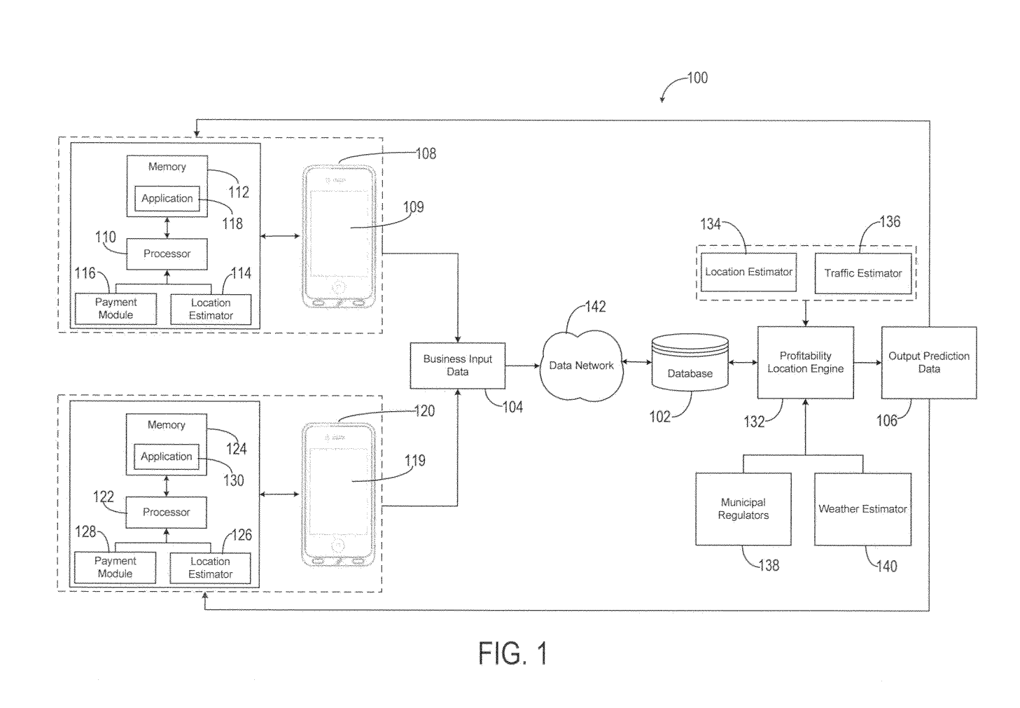

FIG. 1 is a system 100 for identifying profitable locations for mobile business users, such as mobile food trucks. The system 100 includes one or more remote content sources 102, such as a database or non-transitory, computer-readable storage medium on which business input data 104 and output prediction data 106 corresponding to one or more mobile businesses are stored. The system 100 further includes a mobile business user's mobile device 108. The user's mobile device 108 may be, but is not limited to, a portable electronic device such as a cellular telephone, a smart phone, a portable computer, laptop computer, a note-book computer, a smart wristwatch, or a tablet computer. The mobile device 108 may include a display 109, a processor 110, a memory 112, a location estimator 114 (e.g., a global positioning system (GPS)), and a payment module 116. The payment module 116 may be a merchant checkout terminal, a cash register, a mobile credit card processing program, or the like that can be a fixture or part of the mobile business user's mobile device 108. Alternatively, the payment module 116 may be implemented in a computer device that is separate from the user's mobile device 108. In one non-limiting example, the payment module 116 may be an application programming interface (API) connection provided by a network, such as SQUARE, for importing sales and time data from the user's mobile device 108 to the profitability location engine 132. Thus, the profitability location engine 132 may use the sales and time data to track revenue of the mobile business.

In addition, a software application 118, such as a mobile application, may be stored in the memory 112 and executed by the processor 110. The mobile application, or “app”, may comprise computer software designed to help people perform an activity and designed to help the user to perform singular or multiple related specific tasks. It helps to solve problems in the real world by manipulating text, numbers, graphics, or a combination of these elements. In one non-limiting example, the software application 118 may be Software as a service (SaaS) and licensed on a subscription basis to the mobile business user and accessed via a server external to the user's mobile device 108. For example, the SaaS may be centrally hosted on a cloud by independent software vendors (ISVs) or application service providers (ASPs).

As just described, the software modules (e.g., the payment module 116) may interact and/or exchange information via an API. An API may be a software-to-software interface that specifies the protocol defining how independent computer programs interact or communicate with each other. The API may allow a requesting party's software to communicate and interact with the software application 118 and/or its provider—perhaps over a network—through a series of function calls or requests for services. It may comprise an interface provided by the software application 118 and/or its provider to support function calls made of the software application 118 by other computer programs. The API may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof.

Continuing to reference FIG. 1, the system 100 may include a plurality of other mobile devices 120. The other mobile devices 120 can be similar to the mobile device 108 and can be carried by other mobile business users, for example. The other mobile devices 120 may be, but are not limited to, portable electronic devices such as cellular telephones, smart phones, portable computers, laptop computers, note-book computers, smart wristwatches, or tablet computers. Similar to the user's mobile device 108, the other mobile devices 120 may include a display 119, a processor 122, a memory 124, a location estimator 126 (e.g., a GPS system), and a payment module 128. The payment module 128 may be a merchant checkout terminal, a cash register, a mobile credit card processing program (e.g., Square), or the like that can be a fixture or part of the mobile business user's mobile device 120.

In addition, a software application 130, such as a mobile application, may be stored in the memory 124 and executed by the processor 122. In one non-limiting example, the software application 130 may be Software as a service (SaaS) and licensed on a subscription basis to the mobile business user.

Still referring to FIG. 1, the system 100 further includes a profitability location engine 132 that can include one or more processors (not shown) in communication with the remote content source 102 and the mobile business users' mobile devices 108, 120. The profitability location engine 132 may be configured to receive the business input data 104, as will be described in further detail below, from the mobile business users' mobile devices 108, 120. The profitability location engine 132 may be further configured to receive additional input data from a location estimator 134, a traffic estimator 136, municipal regulators 138 (e.g., one or more database storing regulations for one or more municipalities), a weather estimator 140, or a combination thereof. The profitability location engine 132 compiles the business input data 104 and the additional input data to generate the output prediction data 106 to identify one or more profitable locations for the mobile business users.

As a non-limiting example, the location estimator 134 may be an API connection, such as Google Maps API, that is configured to provide map graphics to the display 109 of the mobile device 108. The map graphics are provided to the display 109 of the mobile device 108 in response to the business input data 104 corresponding to a location provided by the location estimator 114 of the mobile device 108. The map graphics may include, but are not limited to, nearby restaurant locations, street names, city names, schools, and the like. As will be described in further detail below, the software application 118 may provide the mobile business user a setup screen to select a specific distance preference from nearby restaurants. Thus, the mobile business user can control how far away to set up their mobile business from potential competitors.

Similar to the location estimator 134, the traffic estimator 136 may be an API connection, that is configured to provide traffic data to the display 109 of the mobile device 108. The traffic data may be provided to the display 109 of the mobile device 108 in response to the business input data 104 corresponding to the location provided by the location estimator 114 of the mobile device 108. Thus, a mobile business user may try to set up at a location with heavy traffic in order to attract the most customers, for example. In one non-limiting example, the traffic estimator 136 and the location estimator 134 may be a single estimator, as shown in FIG. 1. The single estimator may be the Google Maps API which is capable of providing both map graphics and traffic conditions.

The municipal regulators 138, as shown in FIG. 1, may include a municipality's transportation department or education department that can provide the profitability location engine 132 with data related to no parking zones or school zones, for example. Since mobile businesses must comply with certain municipal regulations (e.g., no parking zones or school zones), the profitability location engine 132 can provide this information to the mobile business user through the software application 118. In one non-limiting example, municipal regulations provided by the various municipal regulators 138 could be gathered and stored in a database, such as the database 102 of FIG. 1, and made accessible by the software application 118. Thus, the mobile business user can be up-to-date regarding municipal regulations for their specific set up location that was provided by the location estimator 114 to the profitability location engine 132.

As another example, some municipalities require mobile food businesses to obtain a parking permit from the municipality's transportation department for one or more spaces to ensure clear area in the front and rear of the truck. The profitability location engine 132, therefore, may be configured to provide parking permit information as part of the output prediction data 106 submitted to the mobile business user's mobile device 108, thereby allowing the mobile food business to avoid fines and penalties from the municipality.

Additionally, the weather estimator 140 may be configured to provide weather data to the display 109 of the mobile device 108. The weather data may be provided to the display 109 in response to the business input data 104 that corresponds to the location provided by the location estimator 114 of the mobile device 108. Thus, a mobile business user may try to avoid setting up at a location with poor weather conditions (e.g., rain, snow, etc.) in order to attract the most customers, for example. In one non-limiting example, the weather estimator 140 may be an API connection, such as YAHOO! Weather API, that provides weather data (e.g., temperature and weather conditions) to the profitability location engine 132. The YAHOO! Weather API, for example, uses an RSS feed to provide information about local weather. This information can be dynamically generated, and may be based on either zip code or location.

In another non-limiting example, the weather data can also be integrated into a third party application. Regardless the source of weather data, based on the location data received from the mobile device 108, the profitability location engine 132 can take the weather data from the weather estimator 140 corresponding to the received location and can provide the weather data to the mobile device 108.

The mobile business users' mobile devices 108, 120, the remote content source 102, and the profitability location engine 132 may communicate with one another via a network 142, such as the Internet, local area networks (LANs), wide area networks (WANs), cellular telephone networks or other wireless networks, and the like.

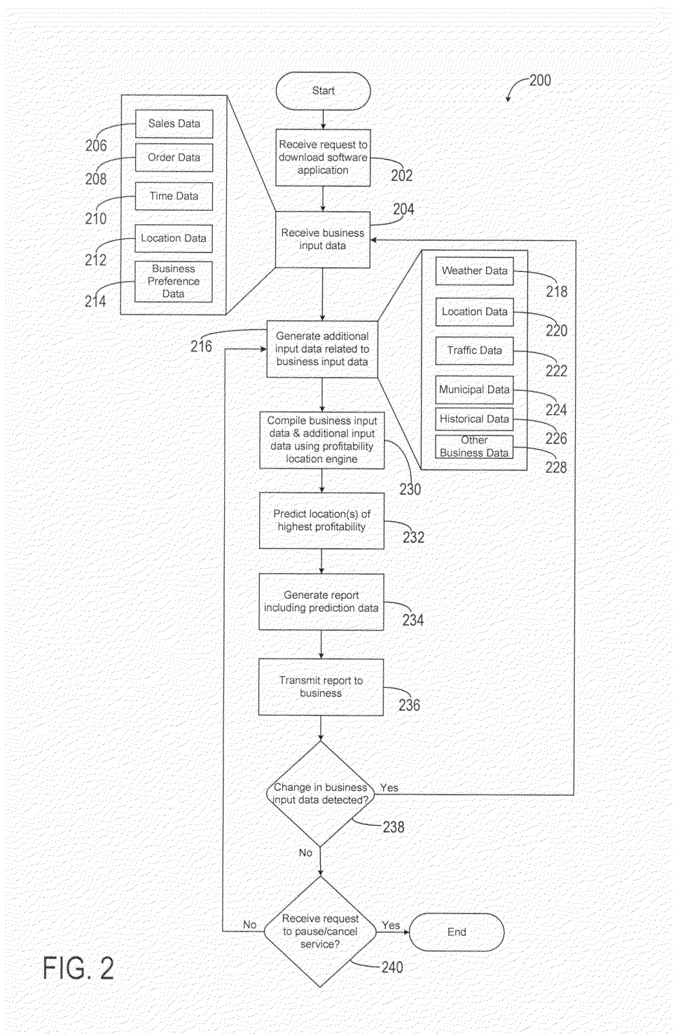

Referring now to FIG. 2, a flow chart 200 setting forth exemplary steps for identifying profitable locations for mobile business users is provided. In the present example, the exemplary steps 200 will be described with respect to steps that may be performed by the profitability location engine 132 of FIG. 1. To start the process, the profitability location engine 132 receives a request from a mobile business user's mobile device, such as the mobile device 108 of FIG. 1, to download the software application 118 at process block 202. The software application 118 may be downloaded from an application software hosting site, such as the Apple Store or the Android App Store, to the user's mobile device 108. The software application 118 stored on the user's mobile device 108 allows the profitability location engine 132 to send output prediction data 106 to the user's mobile device 108 for identifying profitable business locations and, optionally, optimized routes between those profitable business locations.

Once the software application 118 is stored on the mobile business user's device 108, the profitability location engine 132 receives business input data at process block 204, as shown in FIG. 2. The profitability location engine 132 may obtain business input data related to the mobile business including, but not limited to sales data shown at block 206, order data shown at block 208, time data shown at block 210, location data shown at block 212, business preference data shown at block 214, and the like. In one non-limiting example, the sales data 206, the order data 208, and the time data 210 may be acquired from the payment module 116 of FIG. 1 of the mobile business user. The data received in step 204 may include historical data captured over a predetermined time frame or, in some cases, all available historical data. In some cases, some of the data will already be stored in the profitability location engine 132 (e.g., stored as part of a prior request for the business input data). In that case, the stored data may be used and, as such, that data may not be received by the profitability location engine 132—only new data may be received.

More specifically, the sales data 206 may include the revenue received by the mobile business from various business transactions with its customers. For example, if the mobile business is a food truck that sells hot dogs, the sales data 206 can include the revenue for each hot dog sold by the mobile business. Each time a business transaction is made, the payment module 116 of FIG. 1 may send the sales data 206 to the profitability location engine 132 which tracks and stores this data in the remote content source 102.

Order data 208 may include, but is not limited to, specific menu items, for example, provided by the mobile business user. The order data 208 may be categorized by a cuisine type (e.g., Greek, Spanish, Japanese, Mexican, American, etc.) or a menu option type (e.g., appetizer, entrée, drinks, desserts, soups, salads, etc.). Thus, each time a business transaction is made, specific order data 208 may be sent to the profitability location engine 132 which tracks and stores this data in the remote content source 102. In one non-limiting example, the order data 208 may be obtained from the payment module 116 of the mobile device 108. Additionally, by categorizing the order data 208, the profitability location engine 132 can identify one or more profitable locations to recommend to the mobile business user.

Similarly, the time data 210, which corresponds to a time of day or a day of the week, for example, that the business transaction was made, may be obtained from the payment module 116. Thus, each time a business transaction is made (e.g., when menu items are sold) the time data 210 may be sent to the profitability location engine 132 which tracks and stores this data in the remote content source 102. The profitability location engine 132 may then use the time data 210, along with the sales data 206 and order data 208, to identify a profitable time of day for the mobile business user to set up. In one non-limiting example, the profitability location engine 132 may use an algorithm to identify the profitable time of day for the mobile business user to set up. The algorithm may identify, for example, the 15, 30, and 45 most profitable days over the past 30, 60, and 90 days, respectively, and then flatten each day by hour. The algorithm may then be configured to calculate an average on an hourly basis to determine which hour(s) are more profitable than others. In addition, the profitability location engine 132 can identify similar mobile business competitors and use this information to determine certain times that may be more profitable than others to recommend to the mobile business user.

The business input data may also include location data 212 of the mobile business—this may be inferred, for example, based upon the location of the mobile device 108 that is associated with the mobile device. As such, the location data 212 may include a location of the mobile business user's mobile device 108 provided by the location estimator 114. For example, the location data 212 may be in the form of an address, city, state, zip code and country or GPS coordinates, which can be translated into an address. The location data, along with the other business input data, is provided to the profitability location engine 132 of FIG. 1 to provide the mobile business user with one or more profitable locations to set up. In one non-limiting example, if the order data 208 includes mostly Mexican cuisine menu items corresponding to the business transactions, the profitability location engine 132 may be configured to access the remote content source 102 to identify other mobile food businesses selling a similar Mexican cuisine within a certain distance from the mobile business. In addition, the profitability location engine 132 may use the sales data of similar mobile food business within the certain distance to recommend a profitable location for the mobile business user.

Business preference data 214 may also be provided as business input data to the profitability location engine 132. Business preference data 214 may include, for example, a mobile business's preference to be a certain distance from competing mobile businesses or restaurants. As another example, the business preference data 214 may include preferences related to the various settings of the software application 118 provided on the mobile business user's mobile device 108, as will be described in further detail below. For example, the mobile business user may prefer to only receive the location data (i.e., map graphics) and weather data provided by the profitability location engine 132, and exclude the traffic data.

The above-described business input data described with respect to blocks 206, 208, 210, 212, and/or 214 can be used by the profitability location engine 132 of FIG. 1 to identify areas or regions of maximum or increased profitability for the mobile business user. Once the profitability location engine 132 has received the business input data at process block 202, additional input data related to the business input data may be generated at process block 216. The additional input data may include, but is not limited to, weather data as shown at block 218, location data 220 as shown at block 220, traffic data as shown at block 222, municipal data as shown at block 224, historical data 226 as shown at block 226, other business data shown at block 228, and the like.

In one non-limiting example, the profitability location engine 132 may use an algorithm to determine the most profitable set up location for the mobile business user. The algorithm may identify, for example, the 15, 30, and 45 most profitable locations over the past 30, 60, and 90 days, respectively. The identified profitable locations can then be split up, for example, by city, zip code, a mile radius (e.g., by 10, 5, and 1 mile vicinity), or an exact location. The algorithm may then be configured to track the location data 212 each time the mobile business user sets up at the given location, and the algorithm may use the time data 210, weather data 218, location data 212, and order data 208 to determine a score. The score may be a numerical profitability score, for example, and is used to determine which location is more profitable. For example, a profitability score above a predetermined threshold value may indicate a business location of higher profitability, compared to a location having a profitability score below the predetermined threshold.

In one example, the weather data 218 may be provided by the weather estimator 140 of FIG. 1 to the display 109 of the mobile device 108. As previously described, the weather data 218 may be provided to the display 109 in response to the business input data 104 that corresponds to the location provided by the location estimator 114 of the mobile device 108. Thus, the weather data 218 provided to the mobile device 108 corresponds to the location data 212 received at process block 204. Similarly, the location data at block 220 and the traffic data at block 222 may be provided by the location estimator 134 and the traffic estimator 136, respectively, to provide map graphics including traffic patterns to the display 109 of the mobile device 108. As previously described, the map graphics and traffic data are provided to the display 109 of the mobile device 108 in response to the location data provided by the location estimator 114 of the mobile device 108. Thus, the location data 220 and the traffic data 222 provided to the mobile device 108 may also correspond to the location data 212 received at process block 204.

In one non-limiting example, the location data shown at block 220 may be used by the profitability location engine to recommend certain menu items to the mobile business user. For example, if the location data 220 for a profitable location is near a facility, such as an art museum, the profitability location engine may recommend food items appropriate for that location, such as tapas, small plates, and wine. In contrast, if the location data 220 for a profitable location is near a building or construction site, the profitability location engine may recommend food items that appeal to this location, such as hot dogs, hamburgers, and soda. Thus, the profitability location engine is capable of recommending food items for the mobile business to provide depending on the location data 220 and expected customer base.

Municipal data 224 generated at process block 216 may be acquired from the municipal regulators 138, as shown in FIG. 1. The municipal data 224 can include data related to no parking zones, school zones, parking permits, and the like. Based on the location data 212 received at process block 204 of the mobile business user, corresponding municipal data 224 for that location may be generated at process block 216. For example, if the mobile business user's location is Chicago, Ill., the profitability location engine may generate municipal data 224 acquired from Chicago's Department of Transportation and other municipal regulators of Chicago to provide to the mobile business user. Thus, the mobile business user can be assisted in avoiding no parking zones and restricted areas, along with associated fines, for example, in Chicago, Ill.

Historical data 226 may also be generated at process block 216 as additional input data provided by the profitability location engine 132. In one non-limiting example, the historical data 226 may be any of the business input data received at process block 204 from the mobile business user's mobile device 108 and tracked by the profitability location engine 132 over a period of time. Therefore, the profitability location engine 132 can target areas of maximum profitability for the mobile business user based on previously acquired data that was stored in the remote content source 102. For example, if the sales data 206 received from the mobile device 108 at a particular location has been consistently higher than other locations tracked for the mobile device 108 over time, the profitability location engine can use this historical data to identify this particular location as more profitable. In addition, the profitability location engine 132 may use this historical data 226 to help other mobile business users who may not know of profitable locations, for example. Thus, the other mobile devices 120 of FIG. 1 may be able to benefit from the historical data 226 tracked from the mobile device 108.

In another non-limiting example, the historical data shown at block 226 may be historical weather data that has been tracked over time by the profitability location engine 132. Thus, if one of the recommended profitable locations consistently has cooler temperatures, the profitability location engine 132 may recommend that the mobile business user prepare a menu consisting of warmer food items (e.g., soup, hot sandwiches, etc.). In contrast, if one of the recommended profitable locations consistently has warmer temperatures, the profitability location engine 132 may recommend that the mobile business user prepare a menu consisting of cooler food items (e.g., salads, cold sandwiches, ice cream, etc.).

The historical data 226 may further be used by the profitability location engine to recommend a quantity of menu items to stock for the mobile food business. For example, if the historical data 226 indicates that, on average, 100 hot dogs are sold at a particular profitable location each day, the profitability location engine can recommend that the mobile business user stock at least 100 hot dogs for that particular location. Thus, the profitability location engine may help mobile business users to be prepared with the correct quantities and types of menu items at certain set up locations.

Other business data 228 may also be generated as additional input data at process block 216. Other business data 228 may include the historical business data of similar mobile businesses, for example. As just described, if the profitability location engine 132 has tracked the business input data of the plurality of other mobile devices 120 associated with other mobile businesses, as shown in FIG. 1, this data may be defined as other business data 228 and used to identify an area or location of maximum profitability for the mobile business.

Still referring to FIG. 2, once the profitability location engine 132 has generated the necessary additional input data at process block 216, as required by the mobile business user, the profitability location engine 132 may compile the business input data and additional input data at process block 230. By compiling the business input data and additional input data, the profitability location engine 132 can predict one or more profitable locations, as well as other output prediction data as will be described in more detail below, for the mobile business user at process block 232. The profitability location engine 132 may then generate a report at process block 234 that includes the profitable locations and prediction data and transmit the report to the mobile business user at process block 236. The report may be transmitted to and shown on the display 109 of the mobile business user's mobile device 108, as shown in FIG. 1.

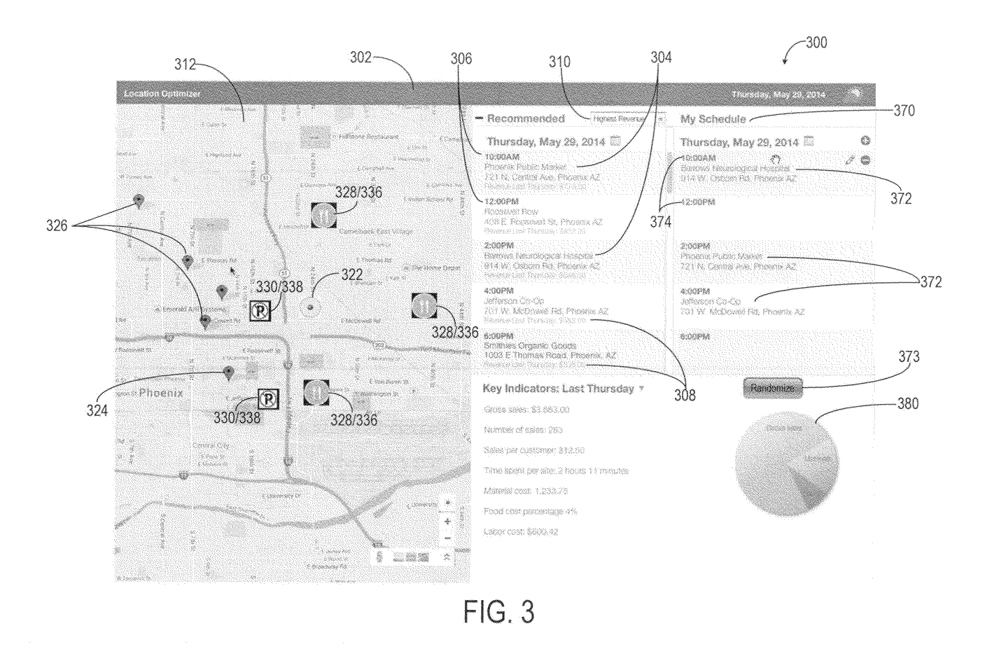

Referring now to FIGS. 3-6, the report transmitted to the mobile business user at process block 236 of FIG. 2, may be displayed on a user interface in one or more formats selected by the mobile business user. The user interface displayed on the mobile device may be any graphical, textual, scanned and/or auditory information a computer program presents to the user, and the control sequences such as keystrokes, movements of the computer mouse, selections with a touch screen, scanned information etc. used to control the program.

Examples of such interfaces include any known or later developed combination of Graphical User Interfaces (GUI) or Web-based user interfaces as seen in and after FIG. 3, including Touch interfaces, Conversational Interface Agents, Live User Interfaces (LUI), Command line interfaces, Non-command user interfaces, Object-oriented User Interfaces (OOUI) or Voice user interfaces. Any information generated by the mobile business user, or any other information, may be accepted using any field, widget and/or control used in such interfaces, including but not limited to a text-box, text field, button, hyper-link, list, drop-down list, check-box, radio button, data grid, icon, graphical image, embedded link, etc.

In one non-limiting example, as shown in FIG. 3, a report 300 is shown on a user interface 302 of a mobile business user's mobile device, such as the mobile device 108 of FIG. 1. The report 300 may include a list 304 of profitable business locations that are selectable by the mobile business user. The report 300 may further include a suggested time 306 (e.g., time of day, day of week, etc.) corresponding to each of the profitable business locations in the list 304. In addition, the report 300 may provide the mobile business user with a predicted profit 308 corresponding to each of the profitable business locations in the list 304, which, as previously described, may be generated based upon the business input data 104 acquired from the mobile device(s) 108, 120 of mobile business users and analyzed by the profitability location engine 132 of FIG. 1.

The predicted profit 308 may be based off of the business user's performance history. In one non-limiting example, the weather data 218 can be used as a multiplier or a divider, such that if the mobile business user would like to know how profitable a particular location will be, the mobile business user may plot the particular location on the map 312, and the profitability location engine 132 can generate the predicted profit 308. The profitability location engine 132 may be configured to calculate the average profit of the plotted location in the past. If the weather data 218 for the plotted location indicates that it's 70 degrees and mild, for example, the average profit is not manipulated. However, if the weather data 218 indicates worsening conditions (e.g., temperatures too hot or too cold) a dividing factor of 10, for example, is applied to the average profit. In another example, if the weather data 218 indicates a weather anomaly (e.g., wind, rain, tornado, etc.) the average profit can be divided by a factor of 20, for example. Thus, nicer weather, as indicated by the weather data 218, may indicate a more normalized predicted profit 308, and poor weather may indicate a lower predicted profit 308 for the plotted location.

In addition, the user interface 302 may provide the mobile business user with an option 310, for example in the form of a drop-down menu, for displaying the list 304 of profitable business locations. For example, as shown in FIG. 3, the list 304 of profitable business locations may be sorted by the highest revenue generated. Alternatively, the drop-down menu 310 may provide the mobile business user with the option to sort the profitable business locations by, but not limited to, closest distance from the mobile business user, closest to the mobile business user's current location, highest quantity of orders, lowest revenue, and random available business locations.

Thus, as the mobile business users travel from one business location to another, the profitability location engine 132 may continuously track the location (e.g., via the location estimator 114, 126), revenue (e.g., via the payment module 116, 128), and time of day business transactions were made (e.g., via the payment module 116, 128) for each mobile business. Therefore, based on the present location of the mobile business user, the profitability location engine 132 may compile the list 304 of the most profitable locations, including the predicted profit 308, to suggest to the business user, for example, that a particular location may be the most profitable. From the list 304 provided on the user interface 302, the mobile business user may select one of the suggested locations to see a map 312, for example, of the area surrounding the selected location.

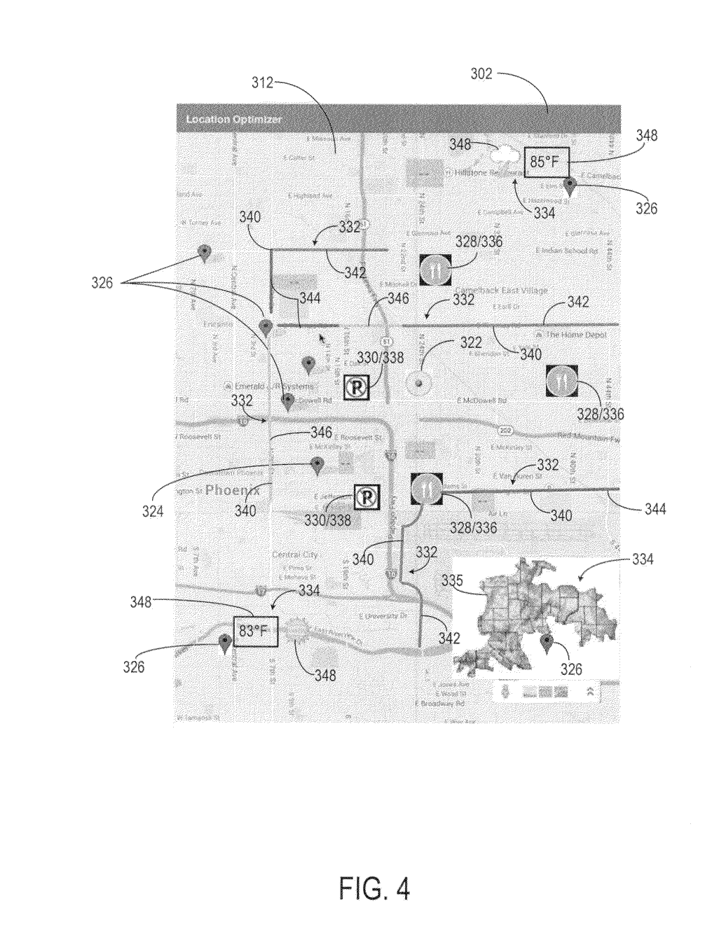

The exemplary map 312 is shown on the user interface 302 in FIG. 3. The map 312 may include, but is not limited to, the mobile business user's current location 322, a selected business location 324, other profitable business locations 326, nearby restaurants 328, and areas to avoid 330 (e.g., do not park zones). The map 312 may also include traffic conditions 332 and weather conditions 334, as shown in FIG. 4. The various features displayed on the map 312 may be adjusted by the mobile business user on a settings user interface, as will be described in further detail below.

Still referring to FIG. 3, the current location 322 of the mobile business user may be acquired from the location estimator (i.e., GPS) of the user's mobile device, for example. The business location 324 selected by the mobile business user from the list 304 is shown on the map 312 relative to the mobile business user's current location 322. The other available business locations 326 may also be displayed on the map 312 relative to the mobile business user's current location 322. The other available business locations 326 may be the other profitable set up locations, as determined by the profitability location engine, shown on the list 304 of FIG. 3 that were not selected by the user, for example. Thus, the mobile business user is provided with a visualization of where the most profitable locations are available to set up relative to their current location 322.

In one non-limiting example, the map 312 may display the nearby restaurants 328 with an indicator 336, such that the mobile business user can decide how close to set up their mobile business to the restaurant. In some instances, the nearby restaurants 328 may be direct competitors of the mobile food business, and thus the mobile business user may want to set up at a different business location 326. In other instances, certain municipalities may require mobile food businesses to park a certain distance away from the nearby restaurants 328. If the latter case, the profitability location engine 132 may automatically inform the mobile business user (i.e., via the map 312) to park a certain distance from the restaurant 328 since these restrictions have already been received from the municipal regulators 138 of FIG. 1, for example.

Similarly, the map 312 shown in FIG. 3 may provide the mobile business user certain areas to avoid 330 (e.g., do not park zones, school zones, etc.) with an indicator 338. Thus, the profitability location engine 132 may automatically inform the mobile business user (i.e., via the indicator 338) of areas to avoid 330 since these restrictions have already been received from the municipal regulators 138 of FIG. 1, for example.

In addition to the various indicators 336, 338 provided on the user interface 302 for the mobile business user, the map 312, as shown in FIG. 4, may also indicate the traffic conditions 332 with color-coded indicators 340, for example. The traffic conditions 332 and corresponding indicators 340 may be provided by the traffic estimator 136 of FIG. 1 to the mobile business user's mobile device 108. The indicators 340 may be displayed as a first color 342 (e.g., green) indicating that the area on the map 312 has little to no traffic. However, if the area on the map 312 has heavy traffic for example, the indicators 340 may be displayed as a second color 344 (e.g., red). For other areas shown on the map 312 having a medium flow of traffic, the indicators 340 may be displayed as a third color 346 (e.g., orange). Thus, the map 312 provides the mobile business user a visual display of the various traffic patterns surrounding the profitable business locations 324, 326 previously identified in the list 304 of FIG. 3. Knowing the various traffic patterns near the current location 322 of the mobile business user may help to make an informed decision as to where to set up. For example, the mobile business user may want to avoid an area showing indicators 340 of heavy traffic due to the inconveniences associated with trying to park. On the contrary, the mobile business user may want to set up in an area showing indicators 340 of heavy traffic due to the potentially increased business traffic.

In yet another non-limiting example, the map 312 may also indicate the weather conditions 334 with weather indicators 348, as shown in FIG. 4 for example. The weather conditions 334 and weather indicators 348 may be provided by the weather estimator 140 of FIG. 1 to the mobile business user's mobile device 108. In one embodiment, the weather indicators 348 may be displayed as an interactive radar map 335 overlaying the map 312. In another embodiment, the weather indicators 348 may be displayed as a heat map overlaying the map 312. In yet another embodiment, the weather indicators 348 may be displayed as a weather layer that displays via text, the current temperature at the various locations on the map 312. The weather layer may also include an icon, for example, that indicates the weather as being one or more of sunny, cloudy, partly cloudy, rainy, snowy, and clear.

Thus, the map 312 provides the mobile business user a visual display of the various weather patterns surrounding the profitable business locations 324, 326 previously identified in the list 304 of FIG. 3. Knowing the various weather patterns near the current location 322 of the mobile business user may help to make an informed decision as to where to set up. For example, the mobile business user may want to avoid an area showing weather indicators 348 of rain which may result in little to no business traffic. On the contrary, the mobile business user may want to set up in an area showing weather indicators 348 of clear conditions due to the potentially increased business traffic.

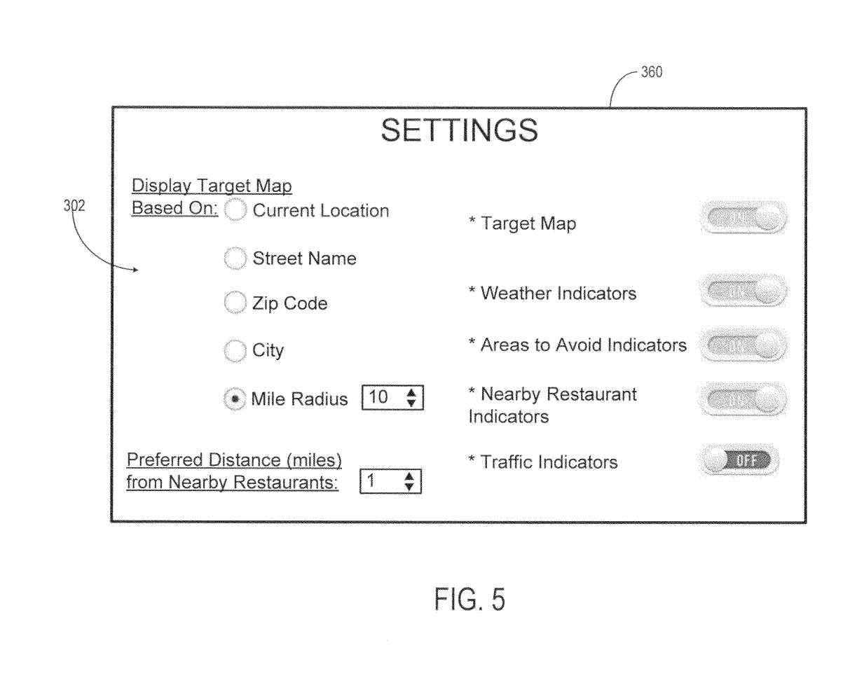

As previously stated, the various features and indicators displayed on the map 312 may be adjusted by the mobile business user on a settings user interface. An exemplary settings screen 360 is shown in FIG. 5 that may be displayed on the user interface 302 of the mobile business user's mobile device, for example. The settings screen 360 may allow the mobile business user to adjust settings on the target area map 312 of FIGS. 3 and 4. In addition, the settings screen 360 may provide the option to display the map 312 based on one or more of the business user's actual location, street name, zip code, city, or by mile radius. For example, the mobile business user may only want to see profitable set up locations within a 10 mile radius of their current locations. Additionally of alternatively, the mobile business user may want the profitable set up locations to be displayed on the map 312 within a certain zip code.

Further, the settings screen 360 may provide the option for the mobile business user to turn the various indicators 336, 338, 340, 348 on or off. For example, if the mobile business user prefers not to see the traffic conditions 332 displayed on the map 312 of FIG. 4, he/she may simply turn this feature off in the settings screen 360 of FIG. 5. In another non-limiting example, the settings screen 360 may provide the mobile business user the option to select a distance of how far away they want to setup from nearby restaurants. Thus, if the mobile business user indicates a distance of one mile, for example, on the settings screen 360 as the distance they would prefer to be from nearby restaurants, the profitability location engine will only suggest profitable set up locations that are greater than one mile from nearby restaurants.

Returning to FIG. 2, if the profitability location engine determines a change in the business input data (e.g., a preferred distance from nearby restaurants) at decision block 238, the profitability location engine 132 returns to process block 204 to receive the revised business input data. At process block 216, the profitability location engine may generate the addition input data based on the revised input data. The process flow continues, as previously described, until the profitability location engine transmits the report to the mobile business user at process block 236.

As another example, the profitability location engine may determine a change in the sales data 206, for example, that the revenues have decreased in a certain location, at decision block 238. As a result, the profitability location engine may predict different profitable locations at process block 232 after compiling the revised business input data and additional input data at process block 230. However, if the profitability location engine detects no change in the business input data at decision block 238, the profitability location engine determines if the mobile business user has requested to pause and/or cancel the service provided by the software application at decision block 240. If the profitability location engine receives a request from the mobile business user to pause or cancel the service provided by the software application at decision block 240, the process ends. However, if the profitability location engine does not receive a request from the mobile business user to pause or cancel the service provided by the software application at decision block 240, the profitability location engine 132 returns to process block 204 to continue receiving the business input data as just described.

Returning now to FIG. 3, the profitability location engine 132 may further be configured to provide the mobile business user with a route schedule 370 on the user interface 302 to instruct the mobile business where to go at a given time of day, for example. The route schedule 370 may be displayed to the user on the user interface 302 in the form of a calendar, for example. Thus, a list 372 of profitable set up locations, as determined by the profitability location engine, may be provided on the route schedule 370 with a corresponding time frame 374 for each set up location. In one non-limiting example, the mobile business user may generate the route schedule 370 based off of past routes that were profitable, for example. Additionally or alternatively, the mobile business user may generate the route schedule 370 by randomly choosing set up locations. In another example, the mobile business user may be provided with a button 373 that, when selected on the user interface 302, instructs the profitability location engine 132 to set up a randomized new route schedule for the mobile business user. This allows the mobile business user to try new set up locations.

The route schedule 370 may be displayed on a daily, weekly, or monthly basis. The corresponding time frame 374 may be displayed as an hourly time frame, as shown in FIG. 3, or alternatively, may be displayed based on a meal (e.g., breakfast, lunch, dinner, etc.). If the mobile business user decides to go to a set up location different from the suggested profitable set up locations on the list 372, the software application may be configured to automatically update the route schedule 370.

Continuing to reference FIG. 3, the profitability location engine may further be configured to display a performance chart 380 for the mobile business user that indicates past performance and/or profitability of the mobile business. The performance chart 380 may be generated by the profitability location engine using the historical business input data corresponding to the mobile business user and stored on the remote content source 102 of FIG. 1. The performance chart 380 may include, but is not limited to, gross sales, quantity of sales, sales per customer, time spent per site, material cost, food cost percentage, and labor cost. In addition, the performance chart 380 may correspond to the mobile business user's locations for a specified time period. For example, the performance chart 380 may be based on the mobile business's locations for the past week, month, year, etc.

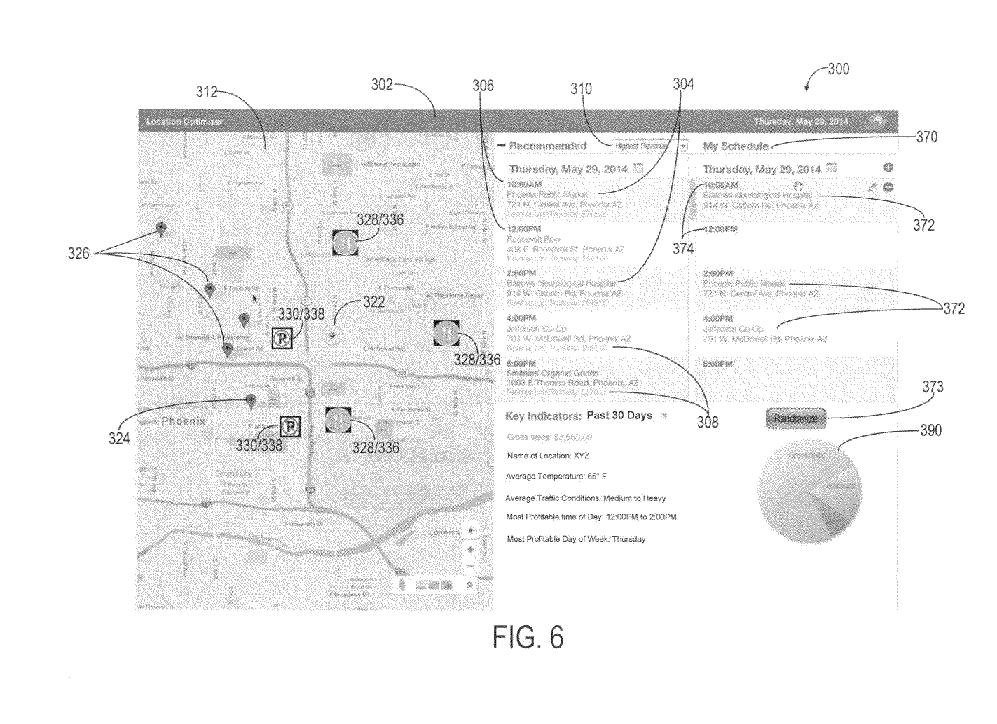

In yet another non-limiting example, as shown in FIG. 6, the profitability location engine may further be configured to display a performance chart or profitability map 390 for the mobile business user that indicates past performance and/or profitability by one or more of location, weather, traffic, day, and time of day. The performance chart 390 may be generated by the profitability location engine using the historical business input data corresponding to the mobile business user and stored on the remote content source 102 of FIG. 1. The performance chart 390 may include, but is not limited to, gross sales, name of location, average temperature, average traffic conditions, most profitable time of day, and most profitable day of week. In addition, the performance chart 390 may correspond to the mobile business user's locations for a specified time period. For example, the profitability map 390 may be based on the mobile business's locations for the past week, month, year, etc.

In one non-limiting example, the mobile business user could retrieve a performance chart 390 for a particular set up location that they have frequently visited over the past 30 days, for example. Thus, the mobile business user can see, graphically, which days were more profitable than others and what the traffic and/or weather conditions were like to help make an informed decision as to where to set up the mobile food business.

Various embodiments of the present invention may be embodied in many different forms, including, but in no way limited to, computer program logic for use with a processor (e.g., a microprocessor, micro controller, digital signal processor, server computer, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as C, C++, or JAVA) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or temporarily in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), or other memory device. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present disclosure describes preferred embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Some embodiments provided for are described as computer-implemented method claims. However, one of ordinary skill in the art would realize that the method steps may be embodied as computer code and the computer code could be placed on a tangible, non-transitory computer readable medium defining a computer program product.

Although the above discussion discloses various exemplary embodiments of the invention, it should be apparent that those skilled in the art can make various modifications that will achieve some of the advantages of the invention without departing from the true scope of the invention.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

1. A method, comprising:
receiving, by a profitability location engine communicatively coupled to a network, a request for a list of profitable locations for at least one mobile business user within a region;
receiving, by the profitability location engine, business input data associated with a business of the at least one mobile business user;
analyzing, by the profitability location engine, the business input data to identify at least one profitable location for the business;
generating, by the profitability location engine, output prediction data including the at least one profitable location for the business; and
displaying, by the profitability location engine, a report including the at least one profitable location to the at least one mobile business user.

2. The method of claim 1, further comprising the step of receiving, by the profitability location engine, additional input data associated with the business input data, wherein the additional input data includes at least one of weather data, location data, time data, traffic data, municipal data, historical data and data associated with another of the at least one mobile business user.

3. The method of claim 2, wherein displaying the report includes depicting for the at least one mobile business user a route schedule generated using the output prediction data, wherein the output prediction data is generated using a combination of the business input data and the additional input data to provide the at least one mobile business user with the route schedule including at least one of time data and location data corresponding to the at least one profitable location.

4. The method of claim 1, wherein the at least one mobile business user includes a mobile food truck.

5. The method of claim 1, wherein receiving the business input data includes receiving at least one of sales data, order data, location data, time data, and business preference data.

6. The method of claim 1, wherein displaying the report to the at least one mobile business user includes generating a map depicting the at least one profitable location and additional profitable locations for the at least one mobile business user, wherein the profitability location engine is configured to display the at least one profitable location and additional profitable locations within a predetermined distance from the at least one mobile business user.

7. The method of claim 1, wherein the region of the at least one mobile business user is specified by at least one of an actual location, a street name, a zip code, a city, and a mile radius.

8. A method, comprising:
transmitting a request, from a mobile device, for a list of profitable locations to a profitability location engine;
transmitting business input data associated with a mobile business to the profitability location engine;
receiving, from the profitability location engine, output prediction data including the list of profitable locations based on the business input data; and
displaying, by the mobile device, at least one of the profitable locations.

9. The method of claim 8, including receiving, in response to the request, a route schedule generated using the output prediction data, wherein the route schedule includes at least one of time data and location data corresponding to the list of profitable locations.

10. The method of claim 8, wherein the mobile business includes a mobile food truck.

11. A system, comprising:
a profitability location engine communicatively coupled to a network, the profitability location engine configured to:
receive a request for a list of profitable locations for at least one mobile business user within a region;
receive business input data associated with a business of the at least one mobile business user;
generate output prediction data including at least one profitable location for the business; and
display a report including the at least one profitable location to the at least one mobile business user.

12. The system of claim 11, wherein the profitability location engine is further configured to generate additional input data associated with the business input data, wherein the additional input data includes at least one of weather data, location data, time data, traffic data, municipal data, historical data and data associated with another of the at least one mobile business user.

13. The system of claim 12, wherein the report is configured to depict for the at least one mobile business user a route schedule generated using the output prediction data, wherein the output prediction data is generated using a combination of the business input data and the additional input data to provide the at least one mobile business user with the route schedule including at least one of time data and location data corresponding to the at least one profitable location.

14. The system of claim 11, wherein the at least one mobile business user includes a mobile food truck.

15. The system of claim 11, wherein the business input data includes at least one of sales data, order data, location data, time data, and business preference data.

16. The system of claim 11, wherein the report further includes a map displaying the at least one profitable location and additional profitable locations for the at least one mobile business user, wherein the profitability location engine is configured to display the at least one profitable location and additional profitable locations within a predetermined distance relative to, and specified by, the at least one mobile business user.

17. The system of claim 16, wherein the profitability location engine includes a plurality of settings corresponding to the map, the plurality of settings enabling the at least one mobile business user to at least one of display a current location, display traffic data, display available setup locations, display daily revenue by location, display nearby restaurants, and display do not park zones.

18. The system of claim 11, wherein the region of the at least one mobile business user is specified by at least one of an actual location, a street name, a zip code, a city, and a mile radius.

19. The system of claim 11, wherein the profitability location engine is further configured to:
track the business input data and the output prediction data over time corresponding to the at least one mobile business user to identify a plurality of profitable locations; and
compare the plurality of profitable locations to one another to determine a highest profitable location based on at least one of sales data, order data, location data, time data, business preference data, weather data, traffic data, municipal data, historical data and data associated with another of the at least one mobile business user.

20. The system of claim 11, wherein the report includes a predicted revenue for the at least one mobile business user at the at least one profitable location generated by the profitability location engine, the predicted revenue based on historical revenue data of another mobile business user accessing the profitability location engine.
